(19) United States
(12) Patent Application Publication
(10) Pub. No.: US 2020/0131291 A1
(43) Pub. Date: Apr. 30, 2020

(54) THREE-DIMENSIONAL MODELING COMPOSITION SET AND THREE-DIMENSIONAL MODELING METHOD

(71) Applicant: Seiko Epson Corporation, Tokyo (JP)

(72) Inventors: Chigusa SATO, Shiojiri (JP); Koki HIRATA, Nagano (JP); Shohei NAMIKOSHI, Shiojiri (JP); Masaya ISHIDA, Torrance, CA (US)

(21) Appl. No.: 16/668,057

(22) Filed: Oct. 30, 2019

(30) Foreign Application Priority Data
Oct. 31, 2018 (JP) 2018-204991

(51) Int. Cl. C08F 224/00; B29C 64/40; B33Y 70/00

(52) U.S. Cl. CPC C08F 224/00; B29C 64/112; B33Y 70/00; B29C 64/40

(57) ABSTRACT

A three-dimensional modeling composition set includes a model material and a support material. The model material contains a heterocyclic acrylate having oxygen as a heteroatom in the molecule and a first photopolymerization initiator. The support material contains a water-soluble polymerizable compound and a second photopolymerization initiator. The heterocyclic acrylate may be an acrylate having one of a dioxane ring structure and a dioxolane ring structure.

The present application is based on, and claims priority from, JP Application Serial Number 2018-204991, filed Oct. 31, 2018, the disclosure of which is hereby incorporated by reference herein in its entirety.

### BACKGROUND

### 1. Technical Field

The present disclosure relates to a three-dimensional modeling composition set and a three-dimensional modeling method.

### 2. Related Art

Three-dimensional modeling has been attracting attention. The three-dimensional modeling is an additive manufacturing method for forming a three-dimensional model by dividing the model data of a three-dimensional object into a large number of two-dimensional cross-sectional layer data, and then layering cross-sectional members one after another while forming cross-sectional members corresponding to each two-dimensional cross-sectional layer data.

Additive manufacturing can rapidly form a three-dimensional structure without preparing any mold in advance, as long as model data of the three-dimensional structure to be formed are available, enabling inexpensive, rapid formation of three-dimensional models. Furthermore, since the thin plate-like cross-sectional members are layered one after another, even a complex object having a specific internal structure can be formed in one body without assembling a plurality of components.

Some three-dimensional modeling methods use a model material that is a UV ink and a support material that is a UV-curable ink containing a water-soluble curable compound, as disclosed in, for example, JP-A-2017-165104.

Unfortunately, in such a method, the model material and the support material are not easily separated after curing. Consequently, the resulting three-dimensional model is likely to have rough surfaces.

### SUMMARY

The subject matter disclosed herein is intended to solve such an issue and is implemented as the following embodiments.

[1] According to an aspect of the present disclosure, a three-dimensional modeling composition set is provided. The composition set includes a model material containing a heterocyclic acrylate having oxygen as a heteroatom in the molecule thereof and a first photopolymerization initiator; and a support material containing a water-soluble polymerizable compound and a second photopolymerization initiator.

[2] In the three-dimensional modeling composition set of [1], the heterocyclic acrylate may be an acrylate having one of a dioxane ring structure and a dioxolane ring structure.

[3] In the three-dimensional modeling composition set of [2], the heterocyclic acrylate may be at least one of (2-methyl-2-ethyl-1,3-dioxolan-4-yl)methyl acrylate and cyclic trimethylolpropane formal acrylate.

[4] In the three-dimensional modeling composition set according to any one of [1] to [3], the heterocyclic acrylate content in the model material may be 50% by mass to 80% by mass.

[5] In the three-dimensional modeling composition set according to any one of [1] to [4], the model material may further contain a multifunctional polymerizable compound.

[6] In the three-dimensional modeling composition set of [5], the multifunctional polymerizable compound content in the model material may be 1.0% by mass to 10% by mass.

[7] In the three-dimensional modeling composition set according to any one of [1] to [6], the first photopolymerization initiator may be at least one compound selected from the group consisting of bis(2,4,6-trimethylbenzoyl)phenylphosphine oxide, 2,4,6-trimethylbenzoyldiphenylphosphine oxide, and 2,4-diethylthioxanthen-9-one.

[8] In the three-dimensional modeling composition set according to any one of [1] to [7], the second photopolymerization initiator may be bis(2,4,6-trimethylbenzoyl)phenylphosphine oxide.

[9] According to another aspect of the present disclosure, a three-dimensional modeling method is provided. The method includes a layer-forming step including ejecting the model material and the support material of the composition set according to any one of [1] to [8] and irradiating the model material and the support material with light. The layer-forming step is performed a plurality of times.

[10] In the three-dimensional modeling method of [9], the model material and the support material may be ejected by an ink jet method.

[11] The three-dimensional modeling method of [9] or [10] may further include a support portion removal step of removing portions defined by the support material after a plurality of times of the layer-forming step.

### BRIEF DESCRIPTION OF THE DRAWINGS

FIG. 1 is a schematic vertical cross-sectional view illustrating an operation for forming a first pattern in a three-dimensional modeling method according to an embodiment of the present disclosure.

FIG. 2 is a schematic vertical cross-sectional view illustrating part of an operation for forming a second pattern in a three-dimensional modeling method according to an embodiment of the present disclosure.

FIG. 3 is a schematic vertical cross-sectional view illustrating an irradiating operation in a three-dimensional modeling method according to an embodiment of the present disclosure.

FIG. 4 is a schematic vertical cross-sectional view illustrating an operation for forming a first pattern in a three-dimensional modeling method according to an embodiment of the present disclosure.

FIG. 5 is a schematic vertical cross-sectional view illustrating an operation for forming a second pattern in a three-dimensional modeling method according to an embodiment of the present disclosure.

FIG. 6 is a schematic vertical cross-sectional view illustrating an irradiating operation in a three-dimensional modeling method according to an embodiment of the present disclosure.

FIG. 7 is a schematic vertical cross-sectional view of the resulting structure after the process of the three-dimensional modeling method according to an embodiment, particularly after a plurality of times of a layer-forming step.

FIG. 8 is a schematic vertical cross-sectional view illustrating a support portion removal step of a three-dimensional modeling method according to an embodiment of the present disclosure.

FIG. 9 is a flow diagram of a three-dimensional modeling method according to an embodiment of the present disclosure.

FIG. 10 is a schematic vertical cross-sectional view of a three-dimensional modeling apparatus used in an embodiment of the present disclosure.

### DESCRIPTION OF EXEMPLARY EMBODIMENTS

An exemplary embodiment of the present disclosure will be described in detail with reference to the attached drawings.

### Three-Dimensional Modeling Method

A three-dimensional modeling method will first be described.

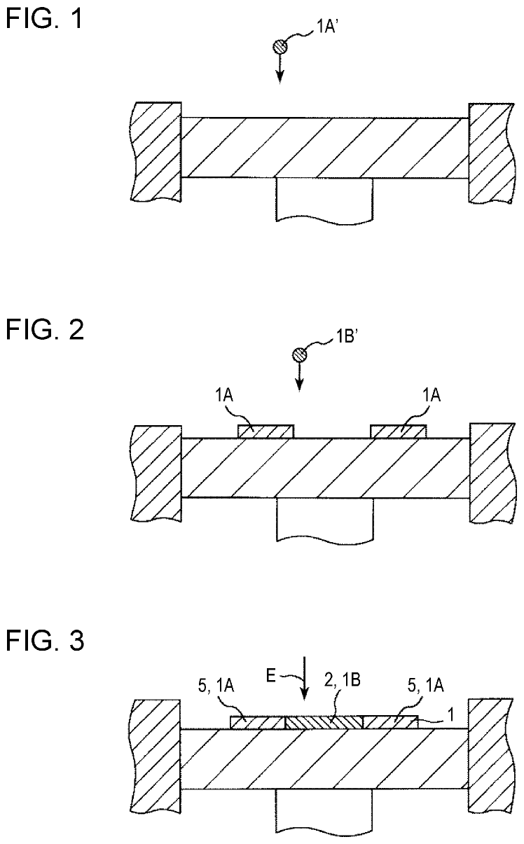

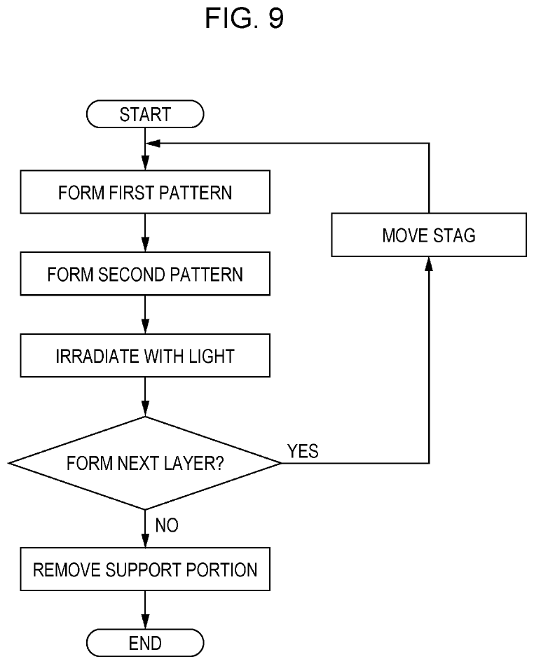

FIGS. 1 to 8 are schematic vertical cross-sectional views illustrating a three-dimensional modeling method according to an embodiment of the present disclosure. FIG. 9 is a flow diagram of a three-dimensional modeling method according to an embodiment of the present disclosure.

A method for forming a three-dimensional model 10 (three-dimensional modeling method) according to an embodiment of the present disclosure includes a layer-forming step including ejecting a model material 1B′ and a support material 1A′ that constitute the three-dimensional modeling composition set described in detail later herein and irradiating the model material 1B′ and the support material 1A′ with light E. The layer-forming step is performed a plurality of times, thus forming a three-dimensional model 10 defined by a multilayer structure including a plurality of layers 1.

This method prevents undesired surface roughness at the surface of the resulting three-dimensional model 10 effectively and enables dimensionally accurate formation of three-dimensional models 10.

In the three-dimensional modeling method for forming a three-dimensional model 10 according to the present embodiment, the layer-forming step of forming layers 1 includes forming a first pattern 1A of a support material 1A′, forming a second pattern 1B of a model material 1B′ so as to come into contact with at least a portion of the first pattern 1A, and irradiating the first pattern 1A and the second pattern 1B with light E. After a multilayer structure 50 has been formed by a plurality of times of the layer-forming step, support portions 5 formed by curing the material 1A′ are removed.

The process steps of the three-dimensional modeling method will now be described in detail.

### First Pattern Formation

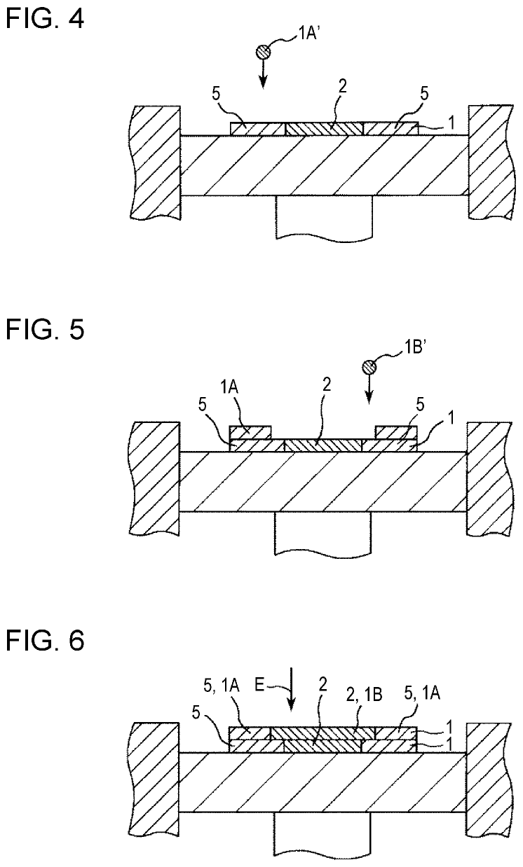

In the formation of a first pattern, a support material 1A′ is ejected to form a first pattern 1A, as shown in FIGS. 1 and 4.

By ejecting the support material 1A′, the first pattern 1A can be favorably formed even if the pattern includes very fine shapes or complex shapes.

The support material 1A′ is used for forming support portions 5. The support portions 5 support or hold second patterns 1B or structure portions 2 made of a model material 1B′ while the three-dimensional model 10 is being formed.

Although the support material 1A′ may be ejected by any technique without particular limitation and may be by, for example, using a dispenser, an ink jet method is beneficial.

The ink jet method facilitates dimensionally accurate formation of three-dimensional models 10, even if the three-dimensional model 10 has a fine structure or a complex structure.

Examples of the ink jet method include methods based on a continuous scheme, such as a charge deflection method, and methods based on an on-demand scheme, such as a piezoelectric method and a bubble jet (registered trademark) method.

When the support material 1A′ are ejected in the form of droplets, the lower limit of the volume per droplet of the support material may be 1 pL, 2 pL, or 3 pL. When the support material 1A′ is ejected in the form of droplets, the upper limit of the volume of a droplet may be 100 pL, 50 pL, or 25 pL.

Thus, even a three-dimensional model 10 having a fine structure can be satisfactorily formed with a high dimensional accuracy, and the productivity of the three-dimensional model 10 can be increased.

The support material 1A′ may include a plurality of compositions. The support material 1A′ will be described in detail later herein.

### Second Pattern Formation

In the formation of a second pattern, a model material 1B′ is ejected to form a second pattern 1B, as shown in FIGS. 2 and 5. The model material 1B′ is used for forming structure portions 2 of the three-dimensional model 10.

By ejecting the model material 1B′, the second pattern 1B can be favorably formed even if the pattern includes very fine shapes or complex shapes.

The model material 1B′ is not compatible with the support material 1A′ as will be described later herein, and the structure portions 2 can easily separate from the support portions 5. Accordingly, undesired roughness at the surface of the structure defined by the structure portions 2 is prevented, and the support portions 5 can be easily removed by the support portion removal operation described later herein. Thus, defects, such as a chip, in the structure portions 2 are prevented effectively.

In the present embodiment, in particular, the model material 1B′ is ejected onto the region surrounded by a first pattern 1A so that the entirety of the periphery of the second pattern can come into contact with the first pattern 1A.

Thus, the dimensional accuracy of the resulting three-dimensional model 10 is further increased.

Although the model material 1B′ may be ejected by any technique without particular limitation and may be by, for example, using a dispenser, an ink jet method is beneficial.

The ink jet method facilitates dimensionally accurate formation of three-dimensional models 10, even if the three-dimensional model 10 has a fine structure or a complex structure.

When the model material 1B′ is ejected in the form of droplets, the lower limit of the volume per droplet of the model material may be 1 pL, 2 pL, or 3 pL. When the model material 1B′ is ejected in the form of droplets, the upper limit of the volume per droplet of the model material may be 100 pL, 50 pL, or 25 pL.

Thus, even a three-dimensional model 10 having a fine structure can be satisfactorily formed with a high dimensional accuracy, and the productivity of the three-dimensional model 10 can be increased.

The model material 1B′ may include a plurality of compositions.

In this instance, the compositions of the model material can be combined according to the properties required for each portion of the three-dimensional model 10 to enhance the characteristics of the three-dimensional model 10 as a whole, including the appearance, the elasticity, the toughness, the heat resistance, and the corrosion resistance. The model material 1B′ will be described in detail later herein.

### Irradiation

In the irradiation, the first pattern 1A and the second pattern 1B are irradiated with light E, as shown in FIGS. 3 and 6.

Thus, the curable components in the first pattern 1A and the second pattern 1B are cured to form a layer 1. At this time, the first pattern 1A defines a support portion 5, and the second pattern 1B defines a structure portion 2. If the layer 1 is formed on a previously formed layer 1 in the present step, as shown in FIG. 6, the support portion 5 of the layer 1 to be formed in the present step will join firmly to the support portion 5 of the underlying layer 1, and the structure portion 2 of the layer 1 to be formed in the present step will join firmly to the structure portion 2 of the underlying layer 1.

Thus, the stability in shape of individual layers 1 including the first pattern 1A and the second pattern 1B is increased, so that the three-dimensional model 10 can be prevented from being collapsed or deformed during modeling.

Any type of light E may be used for irradiation, provided that the light can cure the curable components in the first pattern 1A and the second pattern 1B. For example, a UV light may be used for a curable component that is a UV curable resin.

If UV light is used as the light E, the light E may have a peak wavelength in the range of 10 nm to 400 nm.

The lower limit of the peak wavelength of the UV light may be 20 nm, 30 nm, or 40 nm. The upper limit of the peak wavelength of the UV light may be 420 nm, 390 nm, or 360 nm.

The light E may have peak wavelengths in varying ranges. The light E acting to cure the curable component in the first pattern 1A and the light E acting to cure the curable component in the second pattern 1B may have different spectra from each other.

The first pattern 1A and the second pattern 1B may be subjected to heat treatment while being irradiated with light E. Thus, a curing reaction of the curable component is promoted to increase the productivity of the three-dimensional model 10.

After a layer 1 including a support portion 5 that is a cured first pattern 1A and a structure portion 2 that is a cured second pattern 1B has been formed, another first pattern 1A and another second pattern 1B are formed on the layer 1 in the same manner and then irradiated with light E to yield another layer 1.

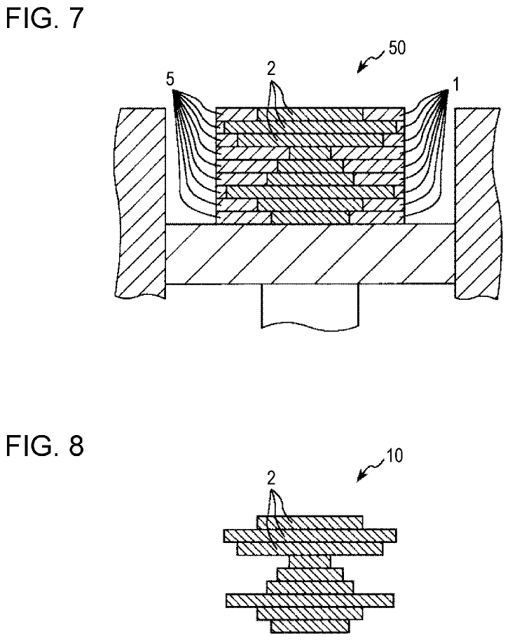

In the formation of the three-dimensional model 10, the layer-forming step including the first pattern formation, the second pattern formation, and the irradiation is performed a plurality of times to form a multilayer structure 50 including a plurality of layers 1, as shown in FIG. 7.

In other words, it is determined whether or not a further layer 1 should be formed on the layer 1 that has just been formed. If should, the further layer 1 is formed, and if not, the multilayer structure 50 is subjected to another operation described in detail later herein.

In the multilayer structure 50, the first patterns 1A of the respective layers 1 may be the same or different among the layers, and the second patterns 1B of the respective layers 1 may be the same or different among the layers 1.

The lower limit of the thickness of each layer 1 formed of the support material 1A′ and the model material 1B′ may be, but is not limited to, 5 μm or 10 μm. The upper limit of the thickness of each layer 1 formed of the support material 1A′ and the model material 1B′ may be, but is not limited to, 100 μm or 50 μm.

When the layers 1 are formed to a thickness in such a range, the productivity and the dimensional accuracy of the three-dimensional model 10 can be increased. Also, when the layers 1 have such a thickness, the curing reaction of the curable component in individual layers can be efficiently promoted by being irradiated with light E.

The thickness of the individual layers 1 of the multilayer structure 50 may be the same or different among the layers 1.

### Support Portion Removal

Subsequently, the support portions 5 are removed from the multilayer structure 50 formed by predetermined times of the layer-forming step, as shown in FIG. 8. In other words, the three-dimensional modeling method of the present embodiment further includes a support portion removal step of removing the support portions 5 defined by the cured product of the first pattern 1A formed of the support material 1A′ in each layer 1 is removed, particularly, at one time after a plurality of times of the layer-forming step. Thus, a three-dimensional model 10 is extracted.

In this step, the support portions 5 defined by the cured product of the first patterns 1A in the layers 1 may be collapsed by, for example, applying a mechanical impact, such as hitting. In some embodiments, however, a liquid containing water may be applied to the multilayer structure 50.

Consequently, the support portions 5 are selectively dissolved or swollen and thus can be easily removed from the structure portions 2. In addition, the use of such a liquid prevents the structure portions 2 from being broken or damaged during the removal of the support portions 5.

The water content in the liquid used for such operation may be 20% by mass or more, 50% by mass or more, or 80% by mass or more.

When the water content is in such a range, the effect of the liquid containing water is enhanced. The upper limit of water in the liquid is 100% by mass.

The liquid containing water may be applied to the multilayer structure 50 by, for example, immersion or spraying. In this instance, ultrasonic vibration or the like may be applied to the multilayer structure 50 and/or the liquid.

According to the method as described above, dimensionally accurate three-dimensional models 10 can be efficiently formed.

If a liquid containing water is applied to the multilayer structure 50 in the present step, the lower limit of the temperature of the liquid may be 5° C., 10° C., or 15° C. Also, the upper limit of the temperature of the liquid may be 80° C., 70° C., or 60° C.

Such a liquid can efficiently remove the support portions 5, increasing the productivity of the three-dimensional model 10. In addition, the constituents of the three-dimensional model 10 can be prevented effectively from being degenerated or degraded.

FIG. 9 shows a flow diagram of the three-dimensional modeling method described above.

### Three-Dimensional Modeling Composition Set

A three-dimensional modeling composition set will now be described.

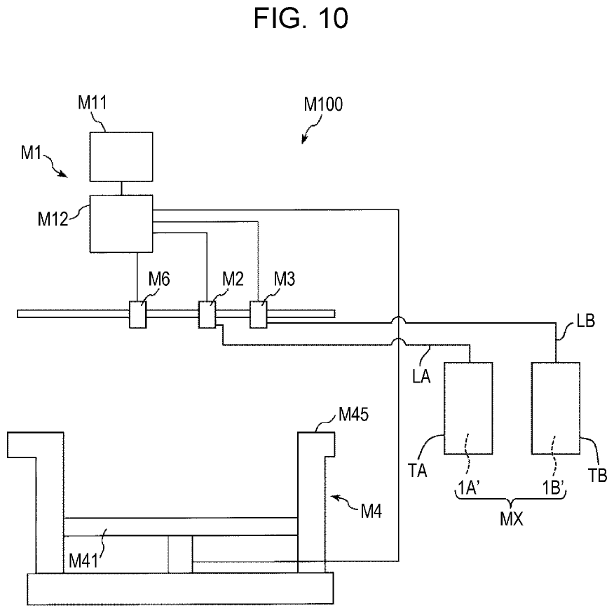

The three-dimensional modeling composition set according to the present disclosure includes a plurality of compositions: a model material 1B′; and a support material 1A′ different from the model material 1B′. The model material 1B′ and the support material 1A′ contain respective constituents as described below. The model material 1B′ includes one or two or more compositions, and the support material 1A′ also includes one or two or more compositions. More specifically, the three-dimensional modeling composition set includes a model material 1B′ containing a heterocyclic acrylate having oxygen as a heteroatom and a first photopolymerization initiator, and a support material 1A′ containing a water-soluble polymerizable compound and a second photopolymerization initiator. As will be described with reference to FIG. 10 later herein, the model material 1B′ and the support material 1A′ of the three-dimensional modeling composition set MX are kept independent of each other without mixing. For example, the model material 1B′ and the support material LA′ may be individually stored in different containers or partitioned spaces.

The use of the three-dimensional modeling composition set MX prevents undesired surface roughness at the surface of the resulting three-dimensional model 10 effectively and results in a dimensionally accurate three-dimensional model 10.

The three-dimensional modeling composition set MX may be used in the above-described three-dimensional modeling method for forming a three-dimensional model 10.

### Model Material

The model material 1B′ of the three-dimensional modeling composition set MX will first be described.

The model material 1B′ is used for forming structure portions 2 of the three-dimensional model 10 and contains a heterocyclic acrylate having oxygen as a heteroatom in the molecule thereof and a first photopolymerization initiator.

### Heterocyclic Acrylate

The heterocyclic acrylate is involved in a polymerization reaction using light E and contains a heterocycle having oxygen as a heteroatom in the molecule.

Such heterocyclic acrylates are, in general, less soluble in water and do not have an affinity for or compatibility with the water-soluble polymerizable compound of the support material 1A′. Also, polymers of such heterocyclic acrylates are, in general, less soluble in water and do not have an affinity for the water-soluble polymerizable compound of the support material 1A′.

The heterocycle of the heterocyclic acrylate may have a dioxane ring structure, a dioxolane ring structure, an epoxy ring structure, an oxetane ring structure, or a tetrahydropyran ring structure. In some embodiments, the heterocyclic acrylate may have a dioxane ring structure or a dioxolane ring structure.

Use of a heterocyclic acrylate having such a structure increases the reactivity of the curing reaction using light E to enhance the strength and the shape stability of the cured product of the curing reaction. Also, such a structure reduces the compatibility of the model material 1B′ with the support material 1A′, facilitating the separation of the structure portions 2 from the support portions 5. Thus, the structure defined by the structure portions 2 is prevented more effectively from having an undesired rough surface, and support portion removal is facilitated. Consequently, the productivity of the three-dimensional model 10 is increased.

Examples of the heterocyclic acrylates include (2-methyl-2-ethyl-1,3-dioxolan-4-yl)methyl acrylate, cyclic trimethylolpropane formal acrylate, (2-isobutyl-2-methyl-1,3-dioxolan-4-yl)methyl acrylate, (2-ethyl-2-methyl-1,3-dioxolan-4-yl)methyl acrylate, (1,4-dioxaspiro[4.5]decan-2-yl)methyl acrylate, tetrafurfuryl alcohol oligoacrylate, alkoxylated tetrahydrofurfuryl acrylate, tetrahydrofurfuryl acrylate, (3-ethyloxetan-3-yl)methyl acrylate, and 4-hydroxybutyl acrylate glycidyl ether. In some embodiments, the heterocyclic acrylate may be at least one of (2-methyl-2-ethyl-1,3-dioxolan-4-yl)methyl acrylate and cyclic trimethylolpropane formal acrylate.

Use of such a heterocyclic acrylate further increases the reactivity of the curing reaction using light E to enhance the strength and the shape stability of the cured product of the curing reaction. Also, such a heterocyclic acrylate further reduces the compatibility of the model material 1B′ with the support material 1A′, further facilitating the separation of the structure portions 2 from the support portions 5. Thus, the structure defined by the structure portions 2 is prevented still more effectively from having an undesired rough surface, and support portion removal is facilitated. Consequently, the productivity of the three-dimensional model 10 is further increased.

The lower limit of the heterocyclic acrylate content in the model material 1B′ may be 50% by mass, 53% by mass, or 55% by mass. Also, the upper limit of the heterocyclic acrylate content in the model material 1B′ may be 80% by mass, 75% by mass, or 72% by mass.

When the heterocyclic acrylate content is in such a range, the strength and the shape stability of the cured product of the curing reaction using light E are further increased. Also, the compatibility of the model material 1B′ with the support material 1A′ is further reduced, and the structure portions 2 can be more easily separated from the support portions 5. Thus, the structure defined by the structure portions 2 is prevented still more effectively from having an undesired rough surface, and support portion removal is facilitated. Consequently, the productivity of the three-dimensional model 10 is further increased.

### First Photopolymerization Initiator

The first photopolymerization initiator initiates a polymerization reaction of the heterocyclic acrylate with light E.

Examples of the first photopolymerization initiator include bis(2,4,6-trimethylbenzoyl)phenylphosphine oxide, 2,4,6-trimethylbenzolyldiphenylphosphine oxide, 2,4-diethylthioxanthen-9-one, 2,2-dimethoxy-1,2-diphenylethan-1-one, 1-hydroxycyclohexylphenyl ketone, 2-hydroxy-2-methyl-1-phenyl-propan-1-one, 1-[4-(2-hydroxyethoxy)phenyl]-2-hydroxy-2-methyl-1-propan-1-one, 2-hydroxy-1-{4-[4-(2-hydroxy-2-methyl-propionyl)-benzyl]phenyl}-2-methyl-propan-1-one, 2-methyl-1-(4-methylthiophenyl)-2-morpholinopropan-1-one, 2-benzyl-2-dimethylamino-1-(4-morpholinophenyl)-butanone-1, 2-(dimethylamino)-2-[(4-methylphenyl)methyl]-1-[4-(4-morpholinyl)phenyl]-1-butanone, bis(η5-2,4-cyclopentadien-1-yl)-bis(2,6-difluoro-3-(1H-pyrrol-1-yl)-phenyl) titanium, 1,2-octanedione, 1-[4-(phenylthio)-, 2-(O-benzoyloxime)], ethanone,1-[9-ethyl-6-(2-methylbenzoyl)-9H-carbazol-3-yl]-,1-(O-acetyloxime), oxyphenylacetic acid, and mixture of oxyphenylacetic acid, 2-[2-oxo-2-phenylacetoxyethoxy]ethyl ester and 2-(2-hydroxyethoxy)ethyl ester. These compounds may be used individually or in combination. In some embodiments, the first photopolymerization initiator may be at least one selected from the group consisting of bis(2,4,6-trimethylbenzoyl)phenylphosphine oxide, 2,4,6-trimethylbenzolyldiphenylphosphine oxide, and 2,4-diethylthioxanthen-9-one.

Such a photopolymerization initiator allows the polymerization reaction of the heterocyclic acrylate having oxygen as a heteroatom to proceed favorably, consequently increasing the productivity of the three-dimensional model 10.

The lower limit of the first photopolymerization initiator content in the model material 1B′ may be 3.0% by mass, 4.0% by mass, or 5.0% by mass. Also, the upper limit of the first photopolymerization initiator content in the model material 1B′ may be 20% by mass, 17% by mass, or 15% by mass.

When the first photopolymerization initiator content is in such a range, the polymerization reaction of the heterocyclic acrylate having oxygen as a heteroatom proceeds more favorably, consequently further increasing the productivity of the three-dimensional model 10. In addition, the strength and the shape stability of the structure portions 2 formed by the curing reaction are further increased.

In some embodiments, the lower limit of the ratio X1/XH of the first photopolymerization initiator content X1 (by mass) to the heterocyclic acrylate content XH (by mass) in the model material 1B′ may be 0.05, 0.10, or 0.15. Also, the upper limit of X1/XH may be 0.40, 0.35, or 0.30.

When the X1/XH ratio is in such a range, the polymerization reaction of the heterocyclic acrylate having oxygen as a heteroatom proceeds more favorably, consequently further increasing the productivity of the three-dimensional model 10. In addition, the strength and the shape stability of the structure portions 2 formed by the curing reaction are further increased.

### Multifunctional Polymerizable Compound

The model material 1B′ may further contain a multifunctional polymerizable compound in addition to the heterocyclic acrylate and the first photopolymerization initiator.

Such a composition can increase the mechanical strength, the shape stability, and the dimensional accuracy of the resulting three-dimensional model 10.

The multifunctional polymerizable compound is a compound having a plurality of functional groups to be involved in the polymerization reaction using light E in the molecule thereof and is otherwise not limited. For example, an aliphatic urethane (meth)acrylate having a plurality of (meth)acryloyl groups in the molecule may be used.

Such a multifunctional polymerizable compound increases the reactivity of the heterocyclic acrylate having oxygen as a heteroatom, consequently increasing the mechanical strength, the shape stability, and the dimensional accuracy of the three-dimensional model 10.

The lower limit of the multifunctional polymerizable compound content in the model material 1B′ may be 1.0% by mass, 1.5% by mass, or 2.0% by mass. Also, the upper limit of the multifunctional polymerizable compound content in the model material 1B′ may be 10% by mass, 8.0% by mass, or 5.0% by mass.

When the multifunctional polymerizable compound content is such a range, the resulting three-dimensional model 10 can exhibits high mechanically strength, shape stability, and dimensionally accuracy.

In some embodiments, the lower limit of the ratio XM/XH of the multifunctional polymerizable compound content XM (by mass) to the heterocyclic acrylate content XH (by mass) in the model material 1B′ may be 0.01, 0.02, or 0.03. Also, the upper limit of XM/XH may be 0.15, 0.12, or 0.10.

Such a composition can further increase the mechanical strength, the shape stability, and the dimensional accuracy of the resulting three-dimensional model 10.

### Further Polymerizable Compound

The model material 1B′ may further contain one or more polymerizable compounds other than the heterocyclic acrylate and the multifunctional polymerizable compound. In the following description, such a polymerizable compound is referred to as a further polymerizable compound.

Examples of the further polymerizable compound include monofunctional monomers having a functional capable of being involved in the polymerization reaction using light E, such as 2-(vinyloxyethoxy)ethyl (meth)acrylate, acryloylmorpholine, isobornyl (meth)acrylate, phenoxyethyl (meth)acrylate, isoamyl (meth)acrylate, stearyl (meth)acrylate, lauryl (meth)acrylate, octyl (meth)acrylate, decyl (meth)acrylate, isomyristyl (meth)acrylate, isostearyl (meth)acrylate, 2-ethylhexyl-diglycol (meth)acrylate, 2-hydroxybutyl (meth)acrylate, 4-hydroxybutyl (meth)acrylate, butoxyethyl (meth)acrylate, ethoxydiethylene glycol (meth)acrylate, methoxydiethylene glycol (meth)acrylate, methoxypolyethylene glycol (meth)acrylate, methoxypropylene glycol (meth)acrylate, tetrahydrofurfuryl (meth)acrylate, 2-hydroxyethyl (meth)acrylate, 2-hydroxypropyl (meth)acrylate, 2-hydroxy-3-phenoxypropyl (meth)acrylate, flexible lactone-modified (meth)acrylate, t-butylcyclohexyl (meth)acrylate, dicyclopentanyl (meth)acrylate, and dicyclopentenyloxyethyl (meth)acrylate; and dimers, trimers, oligomers, and prepolymers thereof. Such compounds may be used individually or in combination.

In some embodiments, 2-(vinyloxyethoxy)ethyl acrylate, acryloylmorpholine, isobornyl acrylate, or phenoxyethyl acrylate may be selected as a further polymerizable compound, and 2-(vinyloxyethoxy)ethyl acrylate may be more beneficial.

Such a polymerizable compound helps increase the reactivity of the model material 1B′ with light E and further increases the mechanical strength, the shape stability, and the dimensional accuracy of the resulting three-dimensional model 10.

The lower limit of the further polymerizable compound content in the model material 1B′ may be 5.0% by mass, 7.0% by mass, or 10% by mass. Also, the upper limit of the further polymerizable compound content in the model material 1B′ may be 45% by mass, 40% by mass, or 30% by mass.

Such a composition can increase the reactivity of the model material 1B′ with light E and increase the mechanical strength, the shape stability, and the dimensional accuracy of the resulting three-dimensional model 10.

In some embodiments, the lower limit of the ratio XO/XH of the further polymerizable compound content XO (by mass) to the heterocyclic acrylate content XH (by mass) in the model material 1B′ may be 0.07, 0.10, or 0.15. Also, the upper limit of XO/XH may be 0.85, 0.80, or 0.75.

Such a composition can increase the reactivity of the model material 1B′ with light E and increase the mechanical strength, the shape stability, and the dimensional accuracy of the resulting three-dimensional model 10.

### Other Constituents

The model material 1B′ may further contain other constituents. Examples of such constituents include a dispersant, a surfactant, a thickener, an aggregation inhibitor, an antifoaming agent, a slipping agent, a coloring agent, such as a pigment or a dye, metal powder, a polymerization inhibitor, a polymerization promoter, a penetration enhancer, a wetting agent, a fixing agent, a fungicide, a preservative, an antioxidant, an ultraviolet absorbent, a chelating agent, a pH adjuster, a resin, and a solvent as a volatile component not involved in the polymerization reaction with light E.

The total content of such constituents in the model material 1B′ may be 5.0% by mass or less, 3.0% by mass or less, or 1.0% by mass or less. The lower limit of such a total content is 0% by mass.

The lower limit of the surface tension at 25° C. of the model material 1B′ may be 20 mN/m, 21 mN/m, or 22 mN/m. Also, the upper limit of the surface tension at 25° C. of the model material 1B′ may be 50 mN/m, 40 mN/m, or 30 mN/m.

Such a model material 1B′ is unlikely to clog the nozzles of the ink jet head and can be satisfactorily ejected with high consistency by an ink jet method. Even if nozzles are clogged, the nozzles can be easily recovered from the clog by putting a cap over the nozzles.

The surface tension may be measured by the Wilhelmy method. In this instance, a surface tensiometer, such as CBVP-7 manufactured by Kyowa Interface Science, may be used.

The lower limit of the viscosity at 25° C. of the model material 1B′ may be 2 mPa·s, 3 mPa·s, or 4 mPa·s. Also, the upper limit of the viscosity at 25° C. of the model material 1B′ may be 12 mPa·s, 10 mPa·s, or 8 mPa·s.

Such a model material 1B′ can be ejected with high consistency and is suitably used for forming layers 1 having an appropriate thickness, consequently increasing the productivity of the three-dimensional model 10. Also, when such a model material 1B′ comes into contact with a surface, the model material does not easily spread excessively over the surface. Consequently, the dimensional accuracy of the resulting three-dimensional model 10 is increased.

The viscosity may be measured with a rheometer MCR-300 manufactured by Physica.

The three-dimensional modeling composition set MX includes at least one composition as the model material 1B′. In an embodiment, a plurality of compositions may be included as the model material 1B′. For example, the three-dimensional modeling composition set MX may include a plurality of model materials 1B′ having different colors from each other. In another embodiment, for example, the three-dimensional modeling composition set MX may include a plurality of model materials 1B′ in which the polymerizable compounds including the heterocyclic acrylate and the first photopolymerization initiator have different proportions.

### Support Material

The support material 1A′ of the three-dimensional modeling composition set MX will now be described.

The support material 1A′ is used for forming support portions 5 that support second patterns 1B made of the model material 1B′ or the structure portions 2 while the three-dimensional model 10 is being formed.

The support material 1A′ contains a water-soluble polymerizable compound and a second photopolymerization initiator.

### Water-Soluble Polymerizable Compound

The water-soluble polymerizable compound is a component involved in a polymerization reaction using light E. The water-soluble polymerizable compound itself is soluble in water, and the polymer produced by the polymerization reaction thereof is compatible with water.

In an embodiment, the water-soluble polymerizable compound may have a solubility of 1.0 g or more in 100 g of water at 25° C.

Such water-soluble polymerizable compounds are highly compatible with and highly soluble in water. Accordingly, the support portions 5 can be favorably removed in the support portion removal step.

Although the solubility of the water-soluble polymerizable compound may be 1.0 g or more in 100 g of water, in some embodiments, it may be 5.0 g or more or 10 g or more in 100 g of water. Such a water-soluble polymerizable compound is effective.

The upper limit of the solubility is not particularly limited and is infinite when the polymerizable compound may be mixed with an arbitrary proportion.

The product of the polymerization reaction of the water-soluble polymerizable compound may have a solubility of 0.5 g or more in 100 g of water at 25° C.

Use of such a water-soluble polymerizable compound facilitates the removal of the support portions 5 in the support portion removal step.

Although the solubility of the polymer of the water-soluble polymerizable compound may be 0.5 g or more in 100 g of water, in some embodiments, it may be 1.0 g or more or 2.0 g or more in 100 g of water. Such a water-soluble polymerizable compound is effective.

The upper limit of the solubility is not particularly limited and is infinite when the polymerizable compound may be mixed with an arbitrary proportion.

Examples of the water-soluble polymerizable compound include N-dimethylacrylamide, methoxy triethylene glycol acrylate, N-diethylacrylamide, acryloylmorpholine, methoxy tetraethylene glycol acrylate, 2-hydroxyethyl acrylate, hydroxypropyl acrylate, 4-hydroxybutyl acrylate, N-(hydroxymethyl)acrylamide, hydroxyethyl acrylamide, isopropylacrylamide, and vinyl caprolactam. Such compounds may be used individually or in combination. In some embodiments, N-dimethylacrylamide, N-diethylacrylamide, or acryloylmorpholine may be used.

Use of such a water-soluble polymerizable compound increases the shape stability of the support portions 5 in the layer-forming step or the like and further facilitates the removal of the support portions 5 in the support portion removal step. Also, such a water-soluble polymerizable compound reduces the compatibility of the model material 1B′ with the support material 1A′ and facilitates the separation between the structure portions 2 and the support portions 5, thus preventing undesired roughness at the surface of the structure defined by the structure portions 2.

The lower limit of the water-soluble polymerizable compound content in the support material 1A′ may be 80% by mass, 85% by mass, or 91% by mass. Also, the upper limit of the water-soluble polymerizable compound content in the support material 1A′ may be 99% by mass, 98% by mass, or 97% by mass.

Use of such a water-soluble polymerizable compound increases the shape stability of the support portions 5 in the layer-forming step or the like and further facilitates the removal of the support portions 5 in the support portion removal step. Also, such a water-soluble polymerizable compound reduces the compatibility of the model material 1B′ with the support material LA′ and facilitates the separation between the structure portions 2 and the support portions 5, thus preventing undesired roughness at the surface of the structure defined by the structure portions 2.

### Second Photopolymerization Initiator

The second photopolymerization initiator initiates a polymerization reaction of the water-soluble polymerizable compound using light E.

The second photopolymerization initiator may be the same or different from the first photopolymerization initiator.

Examples of the second photopolymerization initiator include bis(2,4,6-trimethylbenzoyl)phenylphosphine oxide, 2,4,6-trimethylbenzolyl diphenylphosphine oxide, 2,4-diethylthioxanthen-9-one, 2,2-dimethoxy-1,2-diphenylethan-1-one, 1-hydroxycyclohexylphenyl ketone, 2-hydroxy-2-methyl-1-phenyl-propan-1-one, 1-[4-(2-hydroxyethoxy)phenyl]-2-hydroxy-2-methyl-1-propan-1-one, 2-hydroxy-1-{4-[4-(2-hydroxy-2-methyl-propionyl)-benzyl]phenyl}-2-methyl-propan-1-one, 2-methyl-1-(4-methylthiophenyl)-2-morpholinopropan-1-one, 2-benzyl-2-dimethylamino-1-(4-morpholinophenyl)-butanone-1, 2-(dimethylamino)-2-[(4-methylphenyl)methyl]-1-[4-(4-morpholinyl)phenyl]-1-butanone, bis(115-2,4-cyclopentadien-1-yl)-bis(2,6-difluoro-3-(1H-pyrrol-1-yl)-phenyl) titanium, 1,2-octanedione, 1-[4-(phenylthio)-, 2-(O-benzoyloxime)], ethanone,1-[9-ethyl-6-(2-methylbenzoyl)-9H-carbazol-3-yl]-,1-(O-acetyloxime), oxyphenylacetic acid, and mixture of oxyphenylacetic acid, 2-[2-oxo-2-phenylacetoxyethoxy]ethyl ester and 2-(2-hydroxyethoxy)ethyl ester. These compounds may be used individually or in combination. In some embodiments, the second photopolymerization initiator may be bis(2,4,6-trimethylbenzoyl)phenylphosphine oxide.

Such a photopolymerization initiator allows the polymerization reaction of the water-soluble polymerizable compound to proceed favorably, consequently increasing the productivity of the three-dimensional model 10.

The lower limit of the second photopolymerization initiator content in the support material 1A′ may be 1.0% by mass, 2.0% by mass, or 3.0% by mass. Also, the upper limit of the second photopolymerization initiator content in the support material 1A′ may be 15% by mass, 12% by mass, or 8.0% by mass.

When the second photopolymerization initiator content is in such a range, the polymerization reaction of the water-soluble polymerizable compound proceeds more favorably, consequently further increasing the productivity of the three-dimensional model 10. In addition, the support portions 5 formed by the curing reaction can be more stable in shape.

In some embodiments, the lower limit of the ratio X2/XW of the second photopolymerization initiator content X2 (by mass) to the water-soluble polymerizable compound content XW (by mass) in the support material 1A′ may be 0.01, 0.02, or 0.03. Also, the upper limit of X2/XW may be 0.15, 0.10, or 0.08.

When the X2/XW ratio is in such a range, the polymerization reaction of the water-soluble polymerizable compound proceeds more favorably, consequently further increasing the productivity of the three-dimensional model 10. In addition, the support portions 5 formed by the curing reaction can be stable in shape.

### Other Constituents

The support material 1A′ may further contain other constituents. Examples of such constituents include a dispersant, a surfactant, a thickener, an aggregation inhibitor, an antifoaming agent, a slipping agent, a coloring agent, such as a pigment or a dye, metal powder, a polymerization inhibitor, a polymerization promoter, a penetration enhancer, a wetting agent, a fixing agent, a fungicide, a preservative, an antioxidant, an ultraviolet absorbent, a chelating agent, a pH adjuster, a polymerizable compound other than the water-soluble polymerizable compound, a resin, and a solvent as a volatile component not involved in the polymerization reaction using light E.

The total content of such constituents in the support material 1A′ may be 5.0% by mass or less, 3.0% by mass or less, or 1.0% by mass or less. The lower limit of such a total content is 0% by mass.

The lower limit of the surface tension at 25° C. of the support material 1A′ may be 20 mN/m, 21 mN/m, or 22 mN/m. Also, the upper limit of the surface tension at 25° C. of the support material 1A′ may be 50 mN/m, 40 mN/m, or 30 mN/m.

Such a support material 1A′ is unlikely to clog the nozzles of the ink jet head and can be satisfactorily ejected with high consistency by an ink jet method. Even if nozzles are clogged, the nozzles can be easily recovered from the clog by putting a cap over the nozzles.

The lower limit of the viscosity at 25° C. of the support material 1A′ may be 2 mPa·s, 3 mPa·s, or 4 mPa·s. Also, the upper limit of the viscosity at 25° C. of the support material 1A′ may be 12 mPa·s, 10 mPa·s, or 8 mPa·s.

Such a support material 1A′ can be ejected with high consistency and is suitably used for forming layers 1 having an appropriate thickness, consequently increasing the productivity of the three-dimensional model 10. Also, when such a support material 1A′ comes into contact with a surface, the support material does not easily spread excessively over the surface. Consequently, the dimensional accuracy of the resulting three-dimensional model 10 is increased.

The three-dimensional modeling composition set MX includes at least one composition as the support material 1A′. In an embodiment, a plurality of compositions may be included as the support material 1A′. For example, the three-dimensional modeling composition set MX may include a plurality of support materials 1A′ in which polymerizable compounds including the water-soluble polymerizable compound and the second photopolymerization initiator have different proportions.

### Three-Dimensional Modeling Apparatus

Next, a three-dimensional modeling apparatus will be described. FIG. 10 is a schematic vertical cross-sectional view of a three-dimensional modeling apparatus used in an embodiment of the present disclosure.

The three-dimensional modeling apparatus M100, which is used for modeling or forming a three-dimensional model 10 by performing the formation of a layer 1 a plurality of times, includes a control section M1, a support material ejection nozzle M2 through which the support material 1A′ is ejected to form support portions 5 that will support structure portions 2 defining the structure of the resulting three-dimensional model 10, a model material ejection nozzle M3 through which the model material 1B′ is ejected to form the structure portions 2 of the three-dimensional model 10, and an irradiation device M6 operable for irradiation with light E. The support material ejection nozzle M2 is connected to a first container TA containing the support material 1A′ with a first pipe LA therebetween, and the model material ejection nozzle M3 is connected to a second container TB containing the model material 1B′ with a second pipe LB therebetween. The first pipe LA is provided with a pump (not shown) in the middle thereof to feed the support material 1A′ to the support material ejection nozzle M2 from the first container TA therethrough. The second pipe LB is also provided with a pump (not shown) in the middle thereof to feed the model material 1B′ to the model material ejection nozzle M3 from the second container TB therethrough.

The three-dimensional modeling apparatus can be applied to the three-dimensional modeling method to form dimensionally accurate three-dimensional models 10 with a high productivity without undesirably roughening the surface.

The control section M1 includes a computer M11 and a drive controller M12. The computer M11 is, for example, an ordinary desktop computer containing a CPU and a memory device. The computer M11 generates model data of the three-dimensional model 10 and outputs section data of many sections of the three-dimensional model 10 sliced parallel to each other to the drive controller M12.

The drive controller M12 of the control section M1 functions as a control device to drive the support material ejection nozzle M2, the model material ejection nozzle M3, a layer-forming section M4, and the irradiation device M6. For example, the drive controller M12 controls the operation of the support material ejection nozzle M2 and the model material ejection nozzle M3, the ejection of the support material 1A′ through the support material ejection nozzle M2, the ejection of the model material 1B′ through the model material ejection nozzle M3, the amount of stage M41 lowering, and the irradiation with light E from the irradiation device M6.

The layer forming section M4 includes a stage M41 on which layers 1 formed of the support material 1A′ and model material 1B′ applied thereto are supported, and a frame M45 surrounding the stage M41.

When a layer 1 is formed on another layer 1, the drive controller M12 commands the stage M41 to descend a predetermined amount.

The surface of the stage M41, more specifically, the portion onto which the support material 1A′ and the model material 1B′ are applied, is flat. Therefore, the layers 1 having a uniform thickness are easily formed with reliability.

Beneficially, the stage M41 is made of a high-strength material. For example, the stage M41 may be made of a metal, such as stainless steel.

Also, the stage M41 may be surface-treated to prevent constituents of the support material 1A′ and the model material 1B′ from firmly sticking thereto and to enhance the durability thereof, consequently helping form three-dimensional models 10 stably over a long period. The material used for the surface treatment of the stage M41 may be a fluororesin, such as polytetrafluoroethylene.

The support material ejection nozzle M2 is configured to move and eject the support material LA′ to from a predetermined pattern in a desired position on the stage M41 according to a command from the drive controller M12.

The support material ejection nozzle M2 may be, for example, an ink jet head nozzle or a dispenser nozzle. In some embodiments, an ink jet head nozzle may be used.

Such a nozzle facilitates the formation of dimensionally accurate three-dimensional models 10, even if the three-dimensional model 10 to be formed has a fine structure or a complex structure.

Exemplary ink jet methods include methods based on a continuous scheme, such as a charge deflection method, and methods based on an on-demand scheme, such as a piezoelectric method and a bubble jet (registered trademark) method.

The model material ejection nozzle M3 is configured to move and eject the model material 1B′ to from a predetermined pattern in a desired position on the stage M41 according to a command from the drive controller M12.

The model material ejection nozzle M3 may be, for example, an ink jet head nozzle or a dispenser nozzle. In some embodiments, an ink jet head nozzle may be used.

Such a nozzle facilitates the formation of dimensionally accurate three-dimensional models 10, even if the three-dimensional model 10 to be formed has a fine structure or a complex structure.

The irradiation device M6 is configured to irradiate the layers 1 formed of the support material LA′ and the model material 1B′ with light E according to a command from the drive controller M12.

Thus, a plurality of layers 1 are stacked one after another to form a multilayer structure 50. Subsequently, the support portions 5 are removed from the resulting multilayer structure 50 to extract the three-dimensional model 10.

The removal of the support portions 5 may be performed by using the three-dimensional modeling apparatus M100 or outside the three-dimensional modeling apparatus M100.

### Three-Dimensional Model

The three-dimensional model according to the present disclosure is formed by the three-dimensional modeling method according to an embodiment of the present disclosure using the three-dimensional modeling composition set according to an embodiment of the present disclosure.

Such a three-dimensional model is dimensionally accurate and whose surface is not roughened.

The three-dimensional model is used as, but is not limited to, an appreciation or exhibition objects such as a doll or a figure or a medical device such as an implant.

In addition, the three-dimensional model may also be used as any of a prototype, a mass-produced product, or a made-to-order article.

While the subject matter of the present disclosure has been described with reference to an exemplary embodiment, it is to be understood that the subject matter is not limited to the disclosed embodiment.

For example, in the above-described embodiment, a layer is formed by forming the first pattern and subsequently the second pattern. In an embodiment, however, the first pattern and the second pattern may be formed in the reverse order for at least one layer. A plurality of compositions may be used at one time for different regions. In other words, the first pattern formation and the second pattern formation may be simultaneously performed.

In the above-described embodiment, irradiation of a layer is performed after the first pattern formation and the second pattern formation. In an embodiment, however, the first pattern and the second pattern may be individually irradiated after the respective formations. Also, the first pattern formation and the irradiation of the first pattern may be simultaneously performed, and the second pattern formation and the irradiation of the second pattern may be simultaneously performed.

In the above-described embodiment, the first pattern and the second pattern are formed for all the layers. In an embodiment, however, the multilayer structure may include a layer having no first pattern or a layer having no second pattern. In an embodiment, a layer not including a portion corresponding to the structure portion, for example, a layer defined by only a support portion, may be formed as a sacrifice layer at the surface in contact with the stage.

The steps or operations are performed in any order without being limited to the order described above, and at least some of the steps or operations may be in swapped order.

The three-dimensional modeling method of the present disclosure may optionally include operations for pretreatment, intermediate treatment, and/or after-treatment.

The pretreatment may be an operation of cleaning the stage. The after-treatment may be an operation of, for example, cleaning, burring to adjust the shape, coloring, coating, or heating to increase the polymerization degree of the polymer in the multilayer structure or the three-dimensional model.

Although the three-dimensional modeling method of the disclosed embodiment includes the support portion removal step, the support portions are not necessarily removed in the method and may be removed by the user, the purchaser, or the like of the three-dimensional model.

At least one of the components of the three-dimensional modeling apparatus may be replaced with a member or component having the same function, or any other function may be added.

In the above-described embodiment, layers are formed directly on the surface of the stage. In an embodiment, however, layers may be formed one after another on a modeling plate placed on the stage.

The three-dimensional modeling method disclosed herein does not necessarily use the three-dimensional modeling apparatus as described above.

For example, the above-described modeling apparatus has a function to elevate and descend the stage. In an embodiment, however, the frame or the like, but not the stage, may be elevated and descended, provided that the stage and the frame or the like can be relatively moved.

### EXAMPLES

The subject matter of the present disclosure will be further described in detail with reference to the following Examples. The subject matter is not, however, limited to the examples. The operations described below were performed at room temperature (25° C.) unless otherwise specified. The measurements presented below also are values measured at room temperature (25° C.) unless otherwise specified.

### 1. Preparations of Model Material and Support Material

### Preparation Example A1

Model material A1 was prepared by mixing the following constituents in a predetermined proportion: (2-methyl-2-ethyl-1,3-dioxolan-4-yl)methyl acrylate represented by formula (1) as a heterocyclic acrylate; aliphatic urethane acrylate oligomer CN9893 (produced by Arkema) as a multifunctional polymerizable compound having two acryloyl groups in the molecule thereof; 2-(vinyloxyethoxy)ethyl acrylate represented by formula (2) as a further polymerizable compound; bis(2,4,6-trimethylbenzoyl)phenylphosphine oxide as a photopolymerization initiator; 2,4,6-trimethylbenzoyldiphenylphosphine oxide as a photopolymerization initiator; 2,4-diethylthioxanthen-9-one as a photopolymerization initiator; BYK-3500 (produced by BYK) as a surfactant; and MEHQ (p-methoxyphenol, produced by Tokyo Chemical Industry) as a polymerization inhibitor.

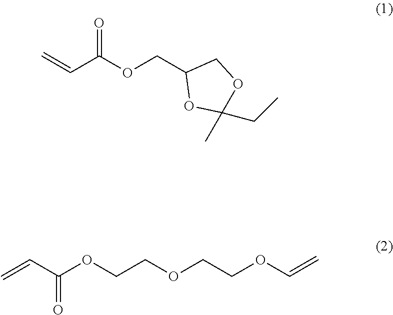

### Preparation Examples A2 to A12

Model materials A2 to A12 were prepared in the same manner as model material A1 except that the constituents and the proportions thereof were changed as presented in Table 1.

### Preparation Example B1

Support material B1 was prepared by mixing the following constituents in a predetermined proportion: N-dimethylacrylamide represented by formula (3) as a water-soluble polymerizable compound; methoxy triethylene glycol acrylate represented by formula (4) as a water-soluble polymerizable compound; and bis(2,4,6-trimethylbenzoyl)phenylphosphine oxide as a photopolymerization initiator.

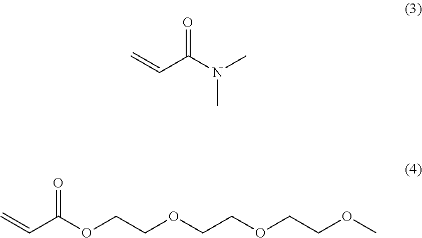

### Preparation Examples B2 to B5

Support materials B2 to B5 were prepared in the same manner as support material B1 except that the constituents and the proportions thereof were changed as presented in Table 2.

Table 1 presents the compositions of the model materials prepared in the above-described Preparation Examples together, and Table 2 presents the compositions of the support materials together. In Tables 1 and 2, H1 as a heterocyclic acrylate represents (2-methyl-2-ethyl-1,3-dioxolan-4-yl)methyl acrylate; H2 as a heterocyclic acrylate represents cyclic trimethylolpropane formal acrylate represented by formula (5); H3 as a heterocyclic acrylate represents tetrahydrofurfuryl acrylate represented by formula (6); H4 as a heterocyclic acrylate represents (3-ethyloxetan-3-yl)methyl acrylate represented by formula (7); H5 as a heterocyclic acrylate represents 4-hydroxybutyl acrylate glycidyl ether represented by formula (8); M1 as a multifunctional polymerizable compound having two acryloyl groups in the molecule represents aliphatic urethane acrylate oligomer CN9893 (produced by Arkema); O1 as a further polymerizable compound represents 2-(vinyloxyethoxy)ethyl acrylate; O2 as a further polymerizable compound represents acryloylmorpholine represented by formula (9); O3 as a further polymerizable compound represents isobornyl acrylate represented by formula (10); O4 as a further polymerizable compound represents phenoxyethyl acrylate represented by formula (11); P1 as a photopolymerization initiator represents bis(2,4,6-trimethylbenzoyl)phenylphosphine oxide; P2 as a photopolymerization initiator represents 2,4,6-trimethylbenzoyldiphenylphosphine oxide; P3 represents 2,4-diethylthioxanthen-9-one; B3500 as a surfactant represents BYK-3500 (produced by BYK); MEHQ as a polymerization inhibitor represents p-methoxyphenol (produced by Tokyo Chemical Industry); W1 as a water-soluble polymerizable compound represents N-dimethylacrylamide; W2 as a water-soluble polymerizable compound represents methoxy triethylene glycol acrylate; W3 as a water-soluble polymerizable compound represents N-diethylacrylamide represented by formula (12); W4 as a water-soluble polymerizable compound represents acryloylmorpholine represented by formula (13); and W5 as a water-soluble polymerizable compound represents methoxy tetraethylene glycol acrylate represented by formula (14) wherein n is 4. Any of the model materials and support materials prepared in the above-described Preparation Examples had a surface tension in the range of 22 mN/m to 30 mN/m. The surface tension was measured at 25° C. by a Wilhelmy method using a surface tensiometer CBVP-7 (manufactured by Kyowa Interface Science). Any of the water-soluble polymerizable compounds used in the support materials prepared in the above-described Preparation Examples had a solubility of 1.0 g or more in 100 g of water at 25° C. In particular, N-dimethylacrylamide, N-diethylacrylamide, and acryloylmorpholine were miscible with water in any proportion. The solubility of the cured product of any of the support materials was 0.5 g or more in 100 g of water at 25° C.

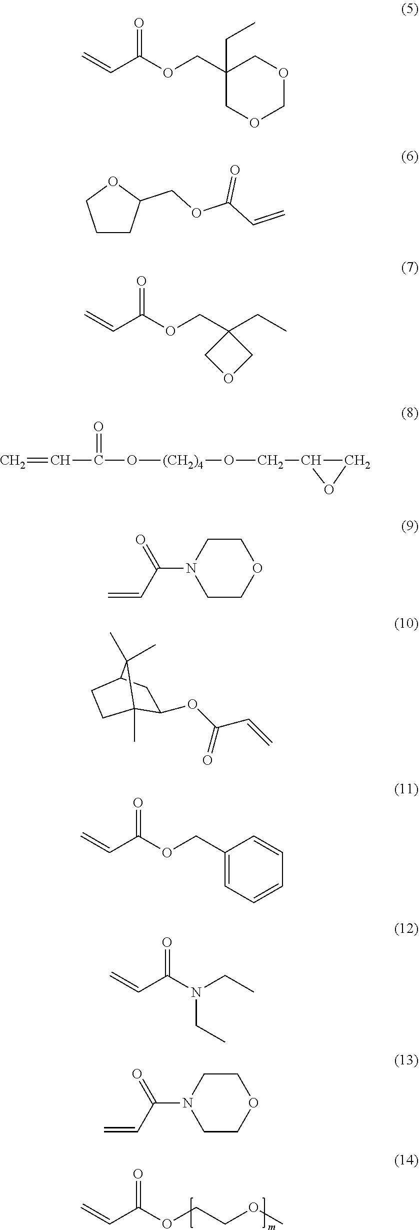

TABLE 1

| | | | Multifunctional | | Further | | | | | | | |
|---|---|---|---|---|---|---|---|---|---|---|---|---|
| | Heterocyclic | | polymerizable | | polymerizable | | Photopolymerization | | | | Polymerization | |
| | acrylate | | compound | | compound | | initiator | | Surfactant | | inhibitor | |
| | | Content | | Content | | Content | | Content | | Content | | Content |
| | | [mass | | [mass | | [mass | | [mass | | [mass | | [mass |
| | Type | %] | Type | %] | Type | %] | Type | %] | Type | %] | Type | %] |
| Preparation Example A1 | H1 | 70 | M1 | 3.6 | O1 | 15 | P1/P2/P3 | 5.0/4.0/2.0 | B3500 | 0.2 | MEHQ | 0.2 |
| Preparation Example A2 | H2 | 70 | M1 | 3.6 | O1 | 15 | P1/P2/P3 | 5.0/4.0/2.0 | B3500 | 0.2 | MEHQ | 0.2 |
| Preparation Example A3 | H1 | 60 | M1 | 3.6 | O1/O4 | 15.0/10.0 | P1/P2/P3 | 5.0/4.0/2.0 | B3500 | 0.2 | MEHQ | 0.2 |
| Preparation Example A4 | H1 | 60 | M1 | 3.6 | O1/O2 | 15.0/10.0 | P1/P2/P3 | 5.0/4.0/2.0 | B3500 | 0.2 | MEHQ | 0.2 |
| Preparation Example A5 | H1 | 60 | M1 | 3.6 | O1/O3 | 15.0/10.0 | P1/P2/P3 | 5.0/4.0/2.0 | B3500 | 0.2 | MEHQ | 0.2 |
| Preparation Example A6 | H3 | 60 | M1 | 3.6 | O1 | 25 | P1/P2/P3 | 5.0/4.0/2.0 | B3500 | 0.2 | MEHQ | 0.2 |
| Preparation Example A7 | H4 | 60 | M1 | 3.6 | O1 | 25 | P1/P2/P3 | 5.0/4.0/2.0 | B3500 | 0.2 | MEHQ | 0.2 |
| Preparation Example A8 | H5 | 60 | M1 | 3.6 | O1 | 25 | P1/P2/P3 | 5.0/4.0/2.0 | B3500 | 0.2 | MEHQ | 0.2 |
| Preparation Example A9 | H1 | 50 | M1 | 3.6 | O1/O4 | 15.0/20.0 | P1/P2/P3 | 5.0/4.0/2.0 | B3500 | 0.2 | MEHQ | 0.2 |
| Preparation Example A10 | — | — | M1 | 3.6 | O1/O4 | 15.0/70.0 | P1/P2/P3 | 5.0/4.0/2.0 | B3500 | 0.2 | MEHQ | 0.2 |
| Preparation Example A11 | — | — | M1 | 3.6 | O1/O2 | 15.0/70.0 | P1/P2/P3 | 5.0/4.0/2.0 | B3500 | 0.2 | MEHQ | 0.2 |
| Preparation Example A12 | — | — | M1 | 3.6 | O1/O3 | 15.0/70.0 | P1/P2/P3 | 5.0/4.0/2.0 | B3500 | 0.2 | MEHQ | 0.2 |

TABLE 2

| | | | Photopolymerization | |
|---|---|---|---|---|
| | Heterocyclic acrylate | | initiator | |
| | | Content | | Content |
| | Compounds | [mass %] | Compound | [mass %] |
| Preparation | W1/W2 | 77.5/17.5 | P1 | 5.0 |
| Example B1 | | | | |
| Preparation | W2/W3 | 17.5/77.5 | P1 | 5.0 |
| Example B2 | | | | |
| Preparation | W2/W4 | 17.5/77.5 | P1 | 5.0 |
| Example B3 | | | | |
| Preparation | W1/W2/W4 | 27.5/17.5/50.0 | P1 | 5.0 |
| Example B4 | | | | |
| Preparation | W4/W5 | 77.5/17.5 | P1 | 5.0 |
| Example B5 | | | | |

### 2. Preparation of Three-Dimensional Modeling Composition Sets and Formation of Three-Dimensional Models

### Example 1

Model material A1 and support material B1 were combined as a three-dimensional modeling composition set.

This three-dimensional modeling composition set was used to form a three-dimensional model as described below.

More specifically, a rectangular solid three-dimensional model measuring 4 mm in thickness by 10 mm in width by 80 mm in length was formed by using the three-dimensional modeling composition set, as described below. The three-dimensional model was designed as a model having flat and smooth surfaces without any protrusions or depressions.

First, a three-dimensional modeling apparatus as shown in FIG. 10 was prepared, and a plurality of droplets of the support material were ejected onto a stage through the support material ejection nozzle that was a piezoelectric ink jet head nozzle to form a predetermined first pattern. At this time, the application amount of the support material was controlled so that the support portion formed by curing the first pattern, that is, the resulting layer, could have a thickness of 15 μm.

Next, a plurality of droplets of the model material were ejected onto the stage through the model material ejection nozzle that was a piezoelectric ink jet head nozzle to form a predetermined second pattern. At this time, the application amount of the model material was controlled so that the structure portion formed by curing the second pattern, that is, the resulting layer, could have a thickness of 10 μm.

Subsequently, the first pattern and the second pattern were irradiated with ultraviolet light from an irradiation device UV-LED. Thus, the curable components in the first pattern and the second pattern were cured to form a support portion and a structure portion, respectively. The light emitted from the UV lamp had a spectrum exhibiting the maximum intensity at a wavelength of 395 nm.

Subsequently, further layers were formed on the previously formed layer by a plurality of times of layer-forming operation including forming a first pattern, forming a second pattern, and irradiating the first and second patterns. Thus, a multilayer structure corresponding to the designed three-dimensional model was obtained.

Next, water of 40° C. was applied to the multilayer structure to dissolve the support portions. Thus, the support portions were removed to yield a three-dimensional model.

### Examples 2 to 13

Three-dimensional models were formed in the same manner as in Example 1, except for using a three-dimensional modeling composition set having a combination of the model material and the support material as presented in Table 3.

### Comparative Examples 1 to 3

Three-dimensional models were formed in the same manner as in Example 1, except for using a three-dimensional modeling composition set having a combination of the model material and the support material as presented in Table 3.

Table 3 presents the combinations of the three-dimensional modeling composition set in each of the Examples and the Comparative Examples together.

TABLE 3

| | Model material | Support material |
|---|---|---|
| Example 1 | Preparation Example A1 | Preparation Example B1 |
| Example 2 | Preparation Example A2 | Preparation Example B1 |
| Example 3 | Preparation Example A3 | Preparation Example B1 |
| Example 4 | Preparation Example A4 | Preparation Example B1 |
| Example 5 | Preparation Example A5 | Preparation Example B1 |
| Example 6 | Preparation Example A6 | Preparation Example B1 |
| Example 7 | Preparation Example A7 | Preparation Example B1 |
| Example 8 | Preparation Example A8 | Preparation Example B1 |
| Example 9 | Preparation Example A9 | Preparation Example B1 |
| Example 10 | Preparation Example A1 | Preparation Example B2 |
| Example 11 | Preparation Example A1 | Preparation Example B3 |
| Example 12 | Preparation Example A1 | Preparation Example B4 |
| Example 13 | Preparation Example A1 | Preparation Example B5 |
| Comparative | Preparation Example A10 | Preparation Example B1 |
| Example 1 | | |
| Comparative | Preparation Example A11 | Preparation Example B1 |
| Example 2 | | |
| Comparative | Preparation Example A12 | Preparation Example B1 |
| Example 3 | | |

### 3. Evaluation

### 3. 1. Viscosity

The viscosities of the model material and the support material of the three-dimensional modeling composition set in each of the Examples and the Comparative Examples were measured at 25° C. with a rheometer MCR-300 (manufactured by Physica) and rated according to the following criteria: A or higher rating is considered to be good.

AA: Compositions had a viscosity of less than 10 mPa·s

A: Compositions has a viscosity of 10 mPa·s to 12 mPa·s

B: Compositions had a viscosity of more than 12 mPa·s

### 3. 2. Odor

For each of the Examples and the Comparative Examples, five volunteers smelled the model material and the support material, and the odor was evaluated according to the following criteria. B or higher rating is considered to be good.

AA: All the five determined that the odor was acceptable.

A: Three or four of the five determined that the odor was acceptable.

B: One or two of the five determined that the odor was acceptable.

C: All the five determined that the odor was not acceptable.

### 3. 3. Curability

For each of the Examples and the Comparative Examples, the curability of 10 μm-thick coatings (cured coatings) of the model material and the support material was evaluated according to the following criteria. A or higher rating is considered to be good.

AA: Cumulative irradiation energy when the coating reached a tack free condition was less than 250 mJ/cm².

A: Cumulative irradiation energy when the coating reached a tack free condition was from 250 mJ/cm² to less than 500 mJ/cm².

B: Cumulative irradiation energy when the coating reached a tack free condition was from 500 mJ/cm² to less than 1000 mJ/cm².

C: Cumulative irradiation energy when the coating reached a tack free condition was 1000 mJ/cm² or more.

### 3. 4. Dimensional Accuracy

For each of the three-dimensional models of the Examples and the Comparative Examples, the thickness, the width, and the length were measured, and differences thereof from the thickness, the width, and the length of the designed model were rated according to the following criteria. The smaller the differences, the better the dimensional accuracy. B or higher rating is considered to be good.

A: The largest of the differences in thickness, width, and length from the designed dimensions was less than 1.0%.

B: The largest of the differences in thickness, width, and length from the designed dimensions was from 1.0% to less than 2.0%.

C: The largest of the differences in thickness, width, and length from the designed dimensions was from 2.0% to less than 4.0%.

D: The largest of the differences in thickness, width, and length from the designed dimensions was from 4.0% to less than 7.0%.

E: The largest of the differences in thickness, width, and length from the designed dimensions was 7.0% or more.

### 3. 5. Surface Roughness

For each of the three-dimensional models of the Examples and the Comparative Examples, the surface roughness Ry at the side surface parallel to the thickness direction of the layers was measured and rated according to the following criteria. The smaller the surface roughness Ry, the more a roughened surface is prevented. B or higher rating is considered to be good.

AA: The support portions were completely removed without forming defects, and the surface roughness Ry was less than 100.

A: The support portions were completely removed without forming defects, and the surface roughness Ry was from 100 to less than 200.

B: The support portions were completely removed without forming defects, and the surface roughness Ry was 200 or more.

C: Part of the model was defective, and the shape of the model was changed.

### 3. 6. Time for Removing Support Portions

In the formation of each three-dimensional model of the Examples and the Comparative Examples, the time for removing the support portions from the multilayer structure was measured and rated according to the following criteria. The shorter the support portion removal time, the higher the productivity of the three-dimensional model. B or higher rating is considered to be good.

AAA: Less than 2 hours

AA: From 2 hours to less than 4 hours

A: From 4 hours to less than 6 hours

B: From 6 hours to less than 8 hours

C: 8 hours or more

All the results are presented together in Table 4.

TABLE 4

| | | | Curability | | | | Support |
|---|---|---|---|---|---|---|---|
| | | | Model | Support | Dimensional | Surface | material |
| | Viscosity | Odor | material | material | accuracy | roughness | removal time |
| Example 1 | AA | AA | A | A | A | AA | AAA |
| Example 2 | A | A | A | A | A | AA | AAA |
| Example 3 | A | A | A | A | A | AA | AAA |
| Example 4 | A | AA | AA | A | A | AA | AAA |
| Example 5 | A | A | A | A | A | AA | AAA |
| Example 6 | AA | AA | A | A | A | AA | AAA |
| Example 7 | AA | A | A | A | A | A | AAA |
| Example 8 | AA | A | A | A | A | A | AAA |
| Example 9 | A | A | A | A | A | A | AAA |
| Example 10 | AA | AA | A | A | A | AA | A |
| Example 11 | AA | AA | A | AA | A | AA | AA |
| Example 12 | AA | AA | A | A | A | AA | AA |
| Example 13 | AA | AA | A | AA | A | AA | A |
| Comparative Example 1 | A | B | B | A | A | B | AAA |
| Comparative Example 2 | B | AA | AA | A | A | C | AAA |
| Comparative Example 3 | AA | C | C | A | A | A | AAA |

As presented in Table 4, the Examples according to the present disclosure produced satisfactory results, while the Comparative Examples did not.

Furthermore, further models were formed by using three-dimensional modeling composition sets in the same manner as the above-described Examples, except for changing the compositions of the model material and the support material as follows: the multifunctional polymerizable compound content in the model material was changed to a value in the range of 1.0% by mass to 10% by mass, the first polymerizable compound content in the model material was changed to a value in the range of 3.0% by mass to 20% by mass, the ratio (XM/XH) of the multifunctional polymerizable compound content (XM) to the heterocyclic acrylate content (XH) in the model material was changed to a value in the range of 0.01 to 0.15, the ratio (X1/XH) of the first photopolymerization initiator content (X1) to the heterocyclic acrylate content (XH) in the model material was changed to a value in the range of 0.05 to 0.40, the water-soluble polymerizable compound content in the support material was changed to a value in the range of 80% by mass to 99% by mass, the second photopolymerization initiator content was changed to a value in the range of 1.0% by mass to 15% by mass, and the ratio (X2/XW) of the second photopolymerization initiator content (X2) to the water-soluble polymerizable compound content (XW) was changed to a value in the range of 0.01 to 0.15. The resulting models were evaluated in the same manner as described above. Similar results to the above results were obtained.

What is claimed is:

1. A three-dimensional modeling composition set comprising:
a model material containing a heterocyclic acrylate having oxygen as a heteroatom in the molecule thereof and a first photopolymerization initiator; and
a support material containing a water-soluble polymerizable compound and a second photopolymerization initiator.

2. The three-dimensional modeling composition set according to claim 1, wherein
the heterocyclic acrylate is an acrylate having one of a dioxane ring structure and a dioxolane ring structure.

3. The three-dimensional modeling composition set according to claim 2, wherein
the heterocyclic acrylate is at least one of (2-methyl-2-ethyl-1,3-dioxolan-4-yl)methyl acrylate and cyclic trimethylolpropane formal acrylate.

4. The three-dimensional modeling composition set according to claim 1, wherein
the heterocyclic acrylate in the model material has a content of 50% by mass to 80% by mass.

5. The three-dimensional modeling composition set according to claim 1, wherein
the model material further contains a multifunctional polymerizable compound.

6. The three-dimensional modeling composition set according to claim 5, wherein
the multifunctional polymerizable compound in the model material has a content of 1.0% by mass to 10% by mass.

7. The three-dimensional modeling composition set according to claim 1, wherein
the first photopolymerization initiator is at least one compound selected from the group consisting of bis(2,4,6-trimethylbenzoyl)phenylphosphine oxide, 2,4,6-trimethylbenzoyldiphenylphosphine oxide, and 2,4-diethylthioxanthen-9-one.

8. The three-dimensional modeling composition set according to claim 1, wherein
the second photopolymerization initiator is bis(2,4,6-trimethylbenzoyl)phenylphosphine oxide.

9. A three-dimensional modeling method comprising:
a layer-forming step including ejecting the model material and the support material of the composition set as set forth in claim 1 and irradiating the model material and the support material with light,
wherein
the layer-forming step is performed a plurality of times.

10. The three-dimensional modeling method according to claim 9, wherein
the model material and the support material are ejected by an ink jet method.

11. The three-dimensional modeling method according to claim 9, further comprising a support portion removal step of removing portions defined by the support material after the plurality of times of the layer-forming step.
